(19) United States
(12) Patent Application Publication
(10) Pub. No.: US 2002/0051172 A1
(43) Pub. Date: May 2, 2002

(54) Method and device for driving a peripheral device according to data signals sent from a portable device

(76) Inventor: Kenji Nomura, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/738,773

(22) Filed: Dec. 18, 2000

(30) Foreign Application Priority Data
Dec. 17, 1999 (JP) 359903/1999

(51) Int. Cl. G06F 15/00

(52) U.S. Cl. 358/1.15

(57) ABSTRACT

In order to drive a peripheral device according to data signals stored in a portable device, the portable device is connected with the peripheral device via a converter device that includes first interface dedicated for the portable device and second interface for the peripheral device. When the portable device sends the data signals to the converter device via the first interface, the converter device generates driving signals for driving the peripheral device according to the data signals and to a driver program dedicated for the peripheral device. Then, the converter sends the driving signals to the peripheral device via the second interface.

### BACKGROUND OF THE INVENTION

1. Field of the Invention

This invention relates to a method and a device for outputting data signals from a portable device to a peripheral device and, in particular, relates to a method and a device for printing data signals stored in a mobile telephone by a printer that is ordinarily connected with a personal computer.

2. Description of the Related Art

Mobile telephones have multi-purpose of use in these days and, therefore, have functions as not only telephone terminal, but also facsimile machine and/or Internet terminal. Therefore, recent mobile telephones always store plural kinds of data, such as facsimile image data, text data and hypertext data.

With reference to FIG. 1, description will be made about a related art for printing data stored in a mobile telephone. A mobile telephone 101 is connected with a facsimile printer 102 via a cable 103. The facsimile printer 102 and the cable 103 are designed only for printing a facsimile image received via mobile telephone and are never used for the other machines.

Naturally, the facsimile printer 102 can print a facsimile image regularly. However, the facsimile printer 102 cannot print web pages or electronic mails in a desirable way. It is needed to decide layout on papers in order to print text data or hypertext data.

Further, most of facsimile data signals are sent as monochrome images so that the facsimile printer 102 is not available for color printing, in spite of the fact that most of web pages are displayed in color.

In order to print web pages and electronic mails in a suitable way, the system shown in FIG. I further requires a personal computer and a printer connected with the computer.

### SUMMARY OF THE INVENTION

It is an object of the present invention to provide a method of outputting data signals stored in a portable device, such as a mobile telephone, in desirable way for type of the data signal.

It is another object of this invention to provide a device that is connected between a portable device and a peripheral device and performs the method.

According to the present invention, a method of driving a peripheral device according to data signals stored in a portable device is provided. The method comprises the following steps. First, the portable device is connected to the peripheral device via a converter device which includes first interface dedicated for the portable device and second interface for the peripheral device. Next, the data signals are sent from the portable device to the converter device via the first interface. Then, the converter device generates driving signals for driving the peripheral device according to the data signals and to a driver program dedicated for the peripheral device. After that, the driving signals are sent from the converter device to the peripheral device via the second interface.

Plural types of data signals may be available for the data signals sent from the portable device to the converter device. In this case, the converter device distinguishes the type of data signals sent from the portable device, and the converter device generates driving signals according to the type of data signals.

Image, which includes facsimile image, text and hypertext data signals may be available for the types of data signals.

The converter device may download the driver program via the mobile telephone.

For example, a mobile telephone may be available for the portable device. A printer may be available for the peripheral device.

Furthermore, according to the present invention, a device for connecting a portable device with a peripheral device is provided. The device comprises: a first interface dedicated for connecting with the portable device; a storage for storing a driver program for driving the peripheral device; a processor for executing the driver program in order to generate driving signals according to data signals received via the first interface; and a second interface for connecting with the peripheral device in order to send the driving signals.

The above-mentioned device may further comprises a unit for distinguishing type of a series of data signals received from the portable device via the first interface, and a unit for generating intermediate signals from the series of data signals according to the type of the series of data signals. The processor generates driving signals according to the intermediate signals. The device may be available for performing the above-mentioned method.

And furthermore, according to the present invention, a method of printing, by a printer, first data signals stored in a portable device is provided. The method comprises the steps of: preparing a unit which connects the printer with the portable device to convert the first data signals into second data signals dedicated for the printer; and sending the second data signals to the printer to print the second data signals. The second data signals may include a printed image signal and/or a command sequence for the printer. The unit may execute a device driver program dedicated for the printer. The portable device may be a mobile telephone.

### BRIEF DESCRIPTION OF THE DRAWING

FIG. 1 is a perspective view of a mobile telephone and a facsimile printer related with the present invention.

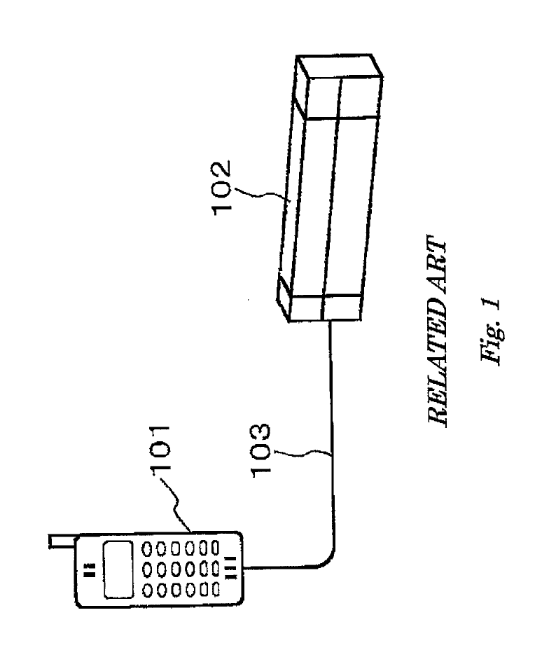

FIG. 2 is a perspective illustration of an embodiment of the present invention.

FIG. 3 shows a block diagram of a data converter 4 of the embodiment.

FIG. 4 is a flowchart for describing an operation of a data-recognizing unit 11 of the data converter 4.

FIG. 5 is a block diagram for describing data conversion in the data converter 4.

FIG. 6 is a perspective illustration of another embodiment of the present invention.

### DESCRIPTION OF THE PREFERRED EMBODIMENTS

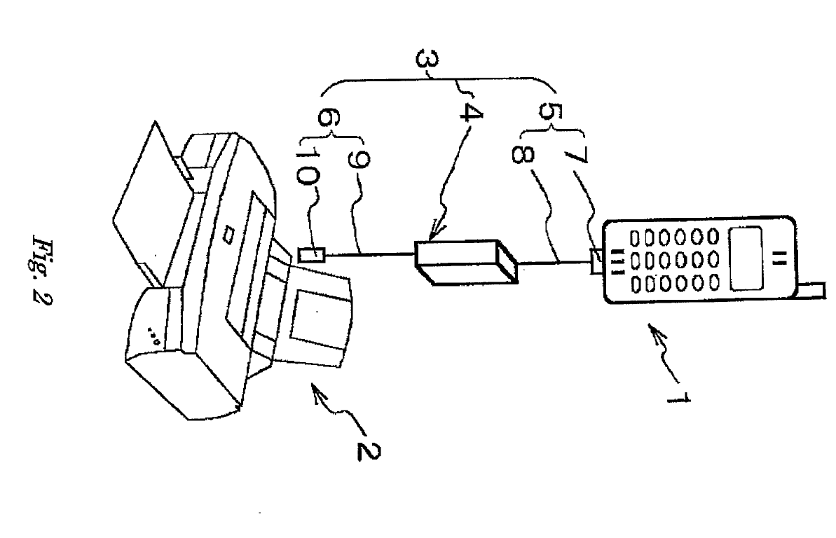

Description will be made about the embodiment of the present invention with reference to FIG. 2. A mobile telephone 1 is connected with a printer 2 via a connecting device 3.

The connecting device 3 is composed of a data converter 4, an input cable 5 and an output cable 6. The input cable 5 is composed of a connector 7 and a cable 8. The output cable 6 is composed of a cable 9 and a connector 10. The connector 7 is coupled to an output port of the mobile telephone 1 while the connector 10 is coupled to an input port of the printer 2.

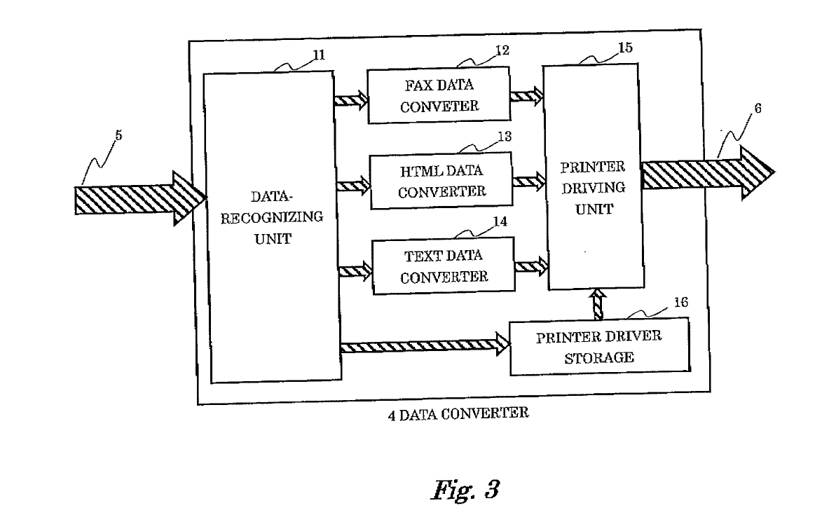

Turning to FIG. 3, the data converter 4 illustrated in FIG. 2 is composed of a data-recognizing unit 11, a fax data converter 12, a HTML (Hypertext Markup Language) data converter 13, a text data converter 14, a printer-driving unit 15, and a printer driver storage 16. The connecting device 3 may be called a mobile terminal dedicated device because it is exclusively used in combination with the mobile terminal, such as the mobile telephone.

The data-recognizing unit 11 is combined with the connector 7. The data-recognizing unit 11 recognizes a type of data signal received from the mobile telephone 1 and then distributes the received data signal to one of the units 12, 13, 14 and 16 in correspondence with type of the received data signal.

The fax data converter 12, the HTML data converter 13 and the text data converter 14 convert fax, HTML and text data signals into intermediate data signals, respectively. Herein, it is to be noted that the intermediate data signals can be interpreted by a device driver program stored in the printer driver storage 16. For example, the intermediate data signals may be data signals for printing one line, bit map data signals of one printed page, or a sequence of commands executed by the printer 2. Each of the units 12, 13 and 14 sends the intermediate data signals to the printer-driving unit 15.

The printer driver storage 16 receives a device driver program for driving the printer 2 from the data-recognizing unit 11 and stores the program.

The printer-driving unit 15 executes the printer driver program and drives the printer 2 via the output cable 6.

The data converter 4 has a push button (not shown). When the push button is pushed, the data converter 4 sends a data request to the mobile telephone 1 via the input cable 5. In response to the data request, the mobile telephone 1 outputs display data signals that are displayed on the display device (not shown) of the mobile telephone 1, and then the display data signals are sent to the printer 2 (FIG. 2) via the input cable 5. The data request may designate one of contents stored in the mobile telephone 1, In this case, the mobile telephone 1 sends data signal corresponding to the designated content back to the data converter 4.

When the data-recognizing unit 11 receives a data signal from the mobile telephone 1, the data-recognizing unit 11 works according to type or content of the received data as the following.

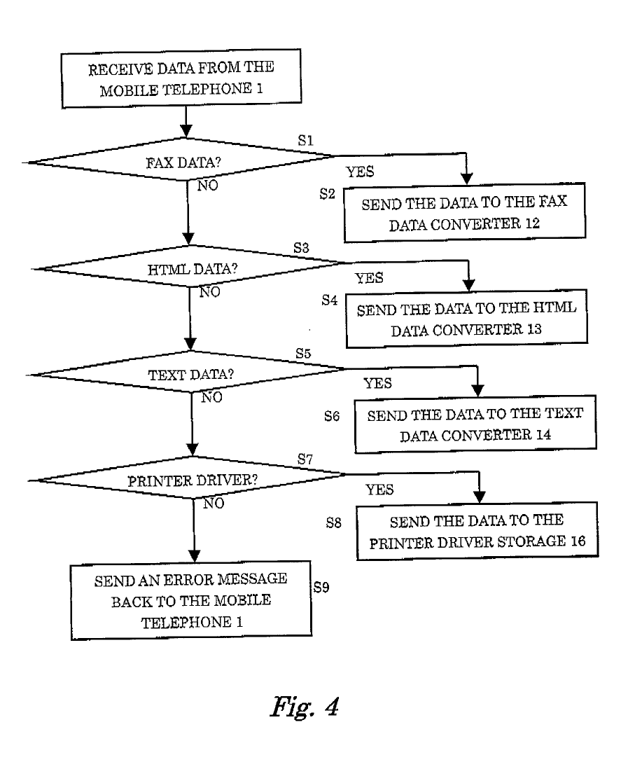

Turning to FIG. 4, first, the data-recognizing unit 11 decides whether the received data signal is a fax data signal (STEP S1). Heads of fax data signals include data for negotiating fax communication so that the data-recognizing unit 11 can recognize a fax data signal with reference to its head. If the received data signal is recognized as a fax data signal, the data-recognizing unit 11 sends the received data signal to the fax data converter 12 (STEP S2).

If the received data signal is not recognized as fax data signal, the data-recognizing unit 11 decides whether the received data signal represents hypertext document (STEP S3). Hypertext document, such as HTML document, includes peculiar header so that the data-recognizing unit 11 recognizes an HTML data signal with reference to its header. If the received data signal is recognized as an HTML data signal, the data-recognizing unit 11 sends the received data signal to the HTML data converter 13 (STEP S4).

If the received data signal is not recognized as an HTML data signal at STEP S3, the data-recognizing unit 11 decides whether the received data signal represents text document (STEP S5). Text document contains character codes included in a predetermined character set so that the data-recognizing unit 11 recognizes a text data signal with reference to codes in the received data signal. If the received data signal is recognized as a text data signal, the data-recognizing unit 11 sends the received data signal to the text data converter 14 (STEP S6).

If the received data signal is not recognized as a text data signal at STEP S6, the data-recognizing unit 11 decides whether or not the received data signal is a device driver program (STEP S7). Each of device driver programs for the data converter 4 contains a header distinguishable from a fax, HTML and text data signal so that the data-recognizing unit 11 recognizes a device driver program with reference to the header of the received data. If the received data signal is recognized as a device driver program, the data-recognizing unit 11 sends the received data signal to the printer driver storage 16 (STEP S8).

If the received data signal is not recognized as a device driver program at STEP S8, the data-recognizing unit 11 returns an error message to the mobile telephone 1 (STEP S9).

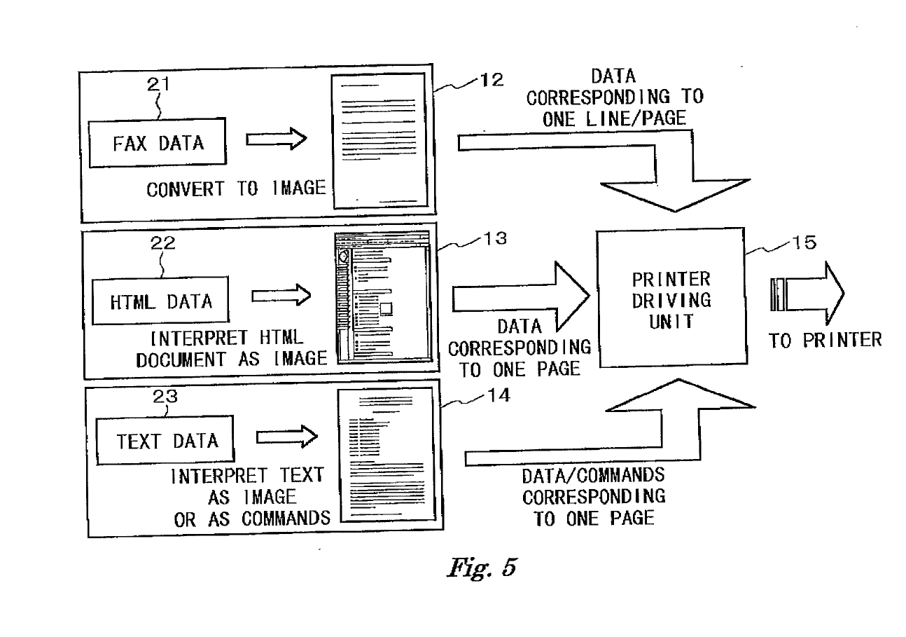

Data signals sent to one of the converters 12, 13 and 14 are converted to the intermediate data as shown in FIG. 5.

A fax data signal 21 sent to the fax data converter 12 is interpreted and converted to the intermediate data signal that is a data signal for printing one line or bitmap data for printing one page. Then, the fax data converter 12 sends the intermediate data signal to the printer driving unit 16.

When the HTML data converter 13 receives an HTML data signal 22, the HTML data converter 13 interprets the HTML data signal 22 to arrange an HTML document on each page. Each page of the HTML document is converted to an intermediate data signal represented as bitmap. Then, the HTML data converter 13 sends the intermediate data signal to the printer driving unit 15.

When the text data converter 14 receives a text data signal 23, the text data converter 14 arranges a text document on each page. Each page is converted to an intermediate data signal and sent to the printer driving unit 15.

The printer driving unit 15 receives the intermediate data signals sent from one of the converter 12, 13 and 14. Next, the printer driver unit 15 further converts the received intermediate data signal to a data signal that is dependent on model of the printer 2 according to the printer driver program for the printer 2. Then, the printer driving unit 15 sends the data signal to the printer 2. If the printer 2 is equipped with more than one font and interpreter of programming language for controlling printer, the printer driving unit 15 may translate the intermediate data signal to commands of the programming language and send the commands to the printer 2, instead of sending bitmap data signal.

Plural printer driver programs may be stored in the printer driver storage 16. A specific one of the programs is used as the printer driver program for the printer 2 by a user of this system, and the specific program is sent from the printer driver storage 16 to the printer driving unit 15. Even if the printer driver storage 16 does not store the printer driver program for the printer 2, the user can download the program from a network via the mobile telephone 1 to the printer driver storage 16. As a result, the user can use a brand-new model printer as the printer 2, and replace a printer driver program stored in the printer driver storage 16 when the program is updated.

According to this invention, data signals stored in a portable device is easily output to a peripheral device, such as a printer. The data signals are output in desirable way according to the data signal type. Furthermore, it is available for updating a driver program of the peripheral device.

While this invention has thus far been described in conjunction with an embodiment thereof, it will be readily possible for those skilled in the art to put the this invention into various other manners.

For example, in the above-mentioned description, the mobile telephone 1 sends a data signal to the data converter 4 in response to a data request from the data converter 4. However, the mobile telephone 1 may voluntarily send a data signal to the data converter 4. In this case, the mobile telephone 1 may include a button for directing the mobile telephone 1 to send a data signal to the data converter 4. Instead, a print command may be added to a menu option displayed on the display device (not shown) of the mobile telephone 1.

The mobile telephone 1 may add header on the top of data signal sent to the data converter 4. In this case, it is simplified to recognize data type by the data-recognizing unit 11.

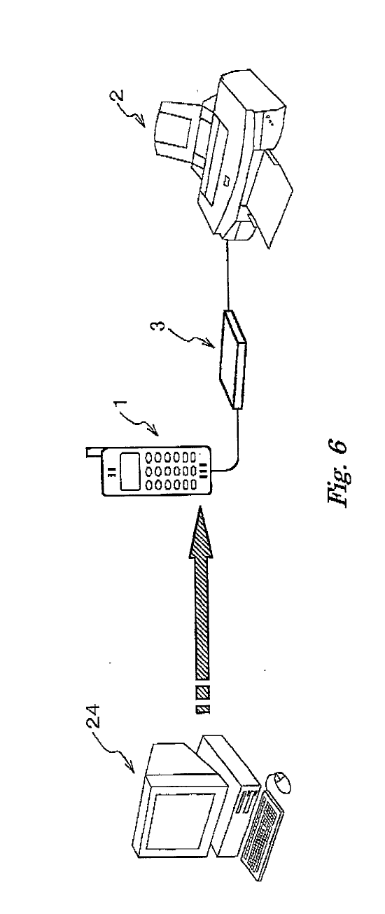

The system mentioned above can realize color facsimile communication in cooperation with a personal computer installed a color facsimile driver program. Turning to FIG. 6, a personal computer 21 installed a color facsimile driver program is connected with the mobile telephone 1 via a public network. The fax data converter 12 accepts not only binary picture, but also color picture. As a result, the printer 2 can print color image data signal sent from the personal computer 21 to the mobile telephone 1 with color.

Connection between the mobile telephone 1 and the printer 2 is connected with wired line. However, the connection may be connected with wireless line.

Any type of printer is available for the printer 2. Further, another peripheral device, such as a storage device and a display device, is available instead of the printer 2.

As mentioned above, this invention enables to connect a portable device with a peripheral device that is commonly used with a personal computer. A device driver program for the peripheral device is to be updated so that type of peripheral device is to be replaced.

What is claimed is:

1. A method of driving a peripheral device according to data signals stored in a portable device, comprising the steps of:
connecting the portable device to the peripheral device via a converter device which includes first interface dedicated for the portable device and second interface for the peripheral device;
sending the data signals from the portable device to the converter device via the first interface;
generating driving signals for driving the peripheral device according to the data signals and to a driver program dedicated for the peripheral device by the converter device; and
sending the driving signals from the converter device to the peripheral device via the second interface.

2. The method claimed in claim 1, wherein:
plural types of data signals are available for the data signals sent from the portable device to the converter device;
the converter device distinguishes the type of data signals sent from the portable device; and
the converter device generates driving signals according to the type of data signals.

3. The method claimed in claim 2, wherein the type of data signals comprises at least one of image, text and hypertext data signals.

4. The method claimed in claim 3, wherein the type of data signals comprises image signals of facsimile data.

5. The method claimed in claim 1, wherein the portable device is a mobile telephone.

6. The method claimed in claim 5, wherein the converter device downloads the driver program via the mobile telephone.

7. The method claimed in claim 1, wherein the peripheral device is a printer.

8. A device for connecting a portable device with a peripheral device, comprising:
a first interface dedicated for connecting with the portable device;
a storage for storing a driver program for driving the peripheral device;
a processor for executing the driver program in order to generate driving signals according to data signals received via the first interface; and
a second interface for connecting with the peripheral device in order to send the driving signals.

9. The device claimed in claim 8:
further comprising means for distinguishing type of a series of data signals received from the portable device via the first interface, and means for generating intermediate signals from the series of data signals according to the type of the series of data signals;
wherein the processor generates driving signals according to the intermediate signals.

10. The device claimed in claim 9, wherein the type of data signals comprises at least one of image, text and hypertext data signals.

11. The device claimed in claim 10, wherein the type of data signals comprises image signals of facsimile data.

12. The device claimed in claim 8, wherein the portable device is a mobile telephone.

13. The device claimed in claim 12, downloading the driver program via the mobile telephone.

14. The device claimed in claim 8, wherein the peripheral device is a printer.

15. The device claimed in claim 8, wherein at least one of the first and second interfaces is wired.

16. A method of printing, by a printer, first data signals stored in a portable device, comprising the steps of:
preparing a unit which connects the printer with the portable device to convert the first data signals into second data signals dedicated for the printer; and
sending the second data signals to the printer to print the second data signals.

17. The method claimed in claim 16, wherein the second data signals include a printed image signal and/or a command sequence for the printer.

18. The method claimed in claim 16, wherein the unit executes a device driver program dedicated for the printer

19. The method claimed in claim 16, wherein the portable device is a mobile telephone.
